(19) United States
(12) Patent Application Publication
(10) Pub. No.: US 2017/0335058 A1
(43) Pub. Date: Nov. 23, 2017

(54) METHOD FOR PRODUCING POLYESTER POLYOLS

(71) Applicant: BASF SE, Ludwigshafen (DE)

(72) Inventors: Kathrin COHEN, Mannheim (DE); Sindhu MENON, Pudong (CN)

(73) Assignee: BASF SE, Ludwigshafen (DE)

(21) Appl. No.: 15/522,447

(22) PCT Filed: Oct. 30, 2015
(86) PCT No.: PCT/EP2015/075235

§ 371 Date: Apr. 27, 2017

(30) Foreign Application Priority Data
Oct. 30, 2014 (EP) 14191153.7

(51) Int. Cl. C08G 63/672; C08G 63/81

(52) U.S. Cl. CPC C08G 63/672; C08G 63/81

(57) ABSTRACT

The present invention relates to a process for preparing polyester polyols and also to the polyester polyols obtainable by the process.

The present invention relates to a process for preparing polyester polyols and also to the polyester polyols obtainable by the process.

Polyester polyols (also referred to as polyester alcohols or PESOLs) are used in various fields of industry, but in particular for producing polyurethane (PU) foams.

For use of the PESOLs for producing PU foams, for example rigid PU foams, it is desirable for the PESOLs to have a relatively low acid number. An acid number of less than or equal to 2 mg KOH/g or preferably 1 mg KOH/g is normally sought.

This is because an excessively high acid number of the PESOL can lead to hydrolysis of the PU foam.

Furthermore, alternatives to petroleum-based raw materials are being examined at present, also as a basis for plastics such as polyurethanes. Owing to the limited supply of fossil resources, bio-based (renewable) raw materials have increasingly moved into focus.

The use of bio-based raw materials for the synthesis of polymers is an up-and-coming trend in the chemical industry. These biorenewable raw materials can typically be prepared from carbohydrates or natural oils. Conversion of glucose into 5-hydroxymethylfurfural (HMF) gives a platform chemical which can be reacted further to give many derivatives, e.g. to give furandicarboxylic acid and tetrahydrobishydroxymethylfuran (THFdiol).

Furandicarboxylic acid is thus a compound which can be obtained from bio-based (renewable) sources.

It would be desirable also to be able to use furandicarboxylic acid as bio-based raw material in the preparation of PESOLs which can subsequently be processed further to give PU foams, in particular rigid PU foams.

The conversion of furandicarboxylic acid into polyester polyalkohols (PESOLs) is already known from the literature and described in a number of patents, e.g. in WO2012/005648, WO2012/005647, WO2012/005645, WO2013/109834. In these patents, the furandicarboxylic acid (FDCA)-based products were mostly prepared in single-stage processes or with use of entrainers such as xylene. However, only products having acid numbers of greater than 1.5 mg KOH/g could be obtained here.

The previously known, abovementioned single-stage and solvent-based processes for preparing polyester polyols using furandicarboxylic acid thus give products having relatively high acid numbers (general greater than 1.5 mg KOH/g), which hinders the use of the polyester polyols obtained for producing PU foams.

It is therefore an object of the invention to provide a process for preparing polyester polyols using furandicarboxylic acid, which gives products having a very low acid number, preferably less than 1 mg KOH/g or more preferably less than 0.8 mg KOH/g. In addition, for reasons of process economics, the use of additional organic solvents, in particular high-boiling organic solvents such as xylene, should be dispensed with as far as possible.

This object has surprisingly been able to be achieved by a two-stage, solvent-free synthesis process in which at least one discarboxylic acid or anhydride thereof is firstly reacted with at least one diol at a relatively high temperature and the water of reaction is largely removed, and only then is the furandicarboxylic acid added at a low temperature and reacted with the reaction mixture after increasing the temperature again.

The present invention accordingly provides a process for preparing polyester polyols by reacting at least one dicarboxylic acid DC and/or at least one dicarboxylic anhydride DCA and also furandicarboxylic acid with at least one at least bifunctional alcohol A, wherein
in a first step (1), the dicarboxylic acids DC and dicarboxylic anhydrides DCA are reacted with the at least bifunctional alcohols A with removal of the water of condensation at a temperature in the range from 100 to 300° C. until at least 80% by weight of the water of condensation have been removed, and
in a second step (2a), after the reaction mixture has reached a temperature in the range from 50 to 150° C., furandicarboxylic acid is added and subsequently
in a next step (2b), the reaction mixture is reacted further at a temperature in the range from 150 to 300° C. until an acid number of less than or equal to 1 mg KOH/g, preferably less than or equal to 0.8 mg KOH/g, has been reached, with an additional organic solvent being used in none of the process steps.

The indication that at least 80% by weight of the water of condensation is removed is based on the total amount of water which can be produced by condensation of the reactants. The amount of water of condensation is determined by means of the water removed by distillation from the reaction vessel.

The indication that, according to the invention, an additional organic solvent is used in none of the reaction steps means that apart from the reactants, which can possibly be considered to be solvents, no solvent is used.

The present invention further provides a polyester polyol preparable by the process of the invention and also provides for the use of the polyester polyol of the invention or preparable by the process of the invention for producing polyurethane foams, preferably rigid polyurethane foams, by reaction with at least one at least bifunctional isocyanate and optionally with at least one blowing agent.

In the context of the present invention, the term “bifunctional alcohol” means a compound having two free (i.e. reactive) alcohol functions.

In one embodiment of the process of the invention, the reaction in step (2b) is carried out to an acid number of less than or equal to 0.7 mg KOH/g, preferably less than or equal to 0.3 mg KOH/g.

To determine the acid number, samples of the reaction mixture are general taken every two to three hours during the process of the invention.

In a further embodiment of the process of the invention, the temperature in the first step (1) is in the range from 150 to 250° C., preferably in the range from 160 to 220° C., particularly preferably in the range from 170 to 190° C.

In one embodiment of the process of the invention, the temperature in step (2a) is in the range from 80 to 120° C., preferably in the range from 90 to 110° C.

In a further embodiment of the process of the invention, the temperature in step (2b) is in the range from 160 to 280° C., preferably in the range from 170 to 240° C., particularly preferably in the range from 190 to 210° C.

In one embodiment of the process of the invention, at least one, preferably all, of the dicarboxylic acids DC are selected from the group consisting of aliphatic and aromatic dicarboxylic acids.

In a further embodiment of the process of the invention, only one dicarboxylic acid DC is used. This dicarboxylic acid DC is preferably adipic acid.

In one embodiment of the process of the invention, at least one, preferably all, of the dicarboxylic anhydrides DCA are selected from the group consisting of aliphatic and aromatic dicarboxylic anhydrides.

In a further embodiment of the process of the invention, at least one, preferably all, of the dicarboxylic anhydrides DCA are selected from the group consisting of aromatic dicarboxylic anhydrides.

In a preferred embodiment of the process of the invention, only one dicarboxylic anhydride DCA is used. This dicarboxylic anhydride is particularly preferably phthalic anhydride.

In a preferred embodiment of the process of the invention, no fatty acids are used.

In a further preferred embodiment of the process of the invention, no monocarboxylic acids are used.

In a preferred embodiment of the process of the invention, the dicarboxylic acid is not furandicarboxylic acid.

In one embodiment of the process of the invention, at least one, preferably all, of the bifunctional alcohols A are selected from the group consisting of aliphatic and aromatic bifunctional alcohols.

In a further embodiment of the process of the invention, at least one, preferably all, of the bifunctional alcohols A are selected from the group consisting of aliphatic bifunctional alcohols.

In a preferred embodiment of the process of the invention, at least one, preferably all, of the bifunctional alcohols A are selected from the group consisting of diethylene glycol (DEG), methyl ethyl glycol (MEG), 2-methyl-1,3-propanediol, 1,4-cyclohexanedimethanol, neopentyl glycol, trimethylolpropane, polyether polyols.

In a further preferred embodiment of the process of the invention, at least one, preferably all, of the bifunctional alcohols A are selected from the group consisting of DEG, MEG, polyether polyols.

In one embodiment of the process of the invention, at least one, preferably all, of the bifunctional alcohols A are selected from the group consisting of DEG.

In one embodiment of the process of the invention, the proportion of furandicarboxylic acid is from 5 to 45% by weight, preferably from 20 to 40% by weight, based on the total batch.

The OH number of the PESOL product obtained is generally in the range from 50 to 300 mg KOH/g. Preferred products have OH numbers in the range from 150 to 300 mg KOH/g, particularly preferably from 160 to 300 mg KOH/g.

The product obtained from the process of the invention is generally liquid at 25° C. “Liquid” means, in particular, a viscosity at 25° C. of from 1 to 40 000 mPas.

In general, the product according to the invention has a viscosity at 75° C. of less than or equal to 40 000 mPas, preferably less than or equal to 15 000 mPas.

As mentioned above, a polyester polyol preparable by the process of the invention is also provided by the present invention.

This polyester polyol has an acid number of less than or equal to 1 mg KOH/g, preferably less than or equal to 0.8 mg KOH/g. The polyester polyol preferably also has an OH number in the range from 50 to 300 mg KOH/g, particularly preferably from 150 to 300 mg KOH/g and very particularly preferably from 160 to 300 mg KOH/g.

The polyester polyol of the invention is preferably liquid at 25° C. and/or has a viscosity at 75° C. of less than or equal to 40 000 mPas, particularly preferably less than or equal to 15 000 mPas.

The polyester polyol of the invention is a PESOL comprising building blocks originating from furandicarboxylic acid. The proportion of the units derived from furandicarboxylic acids is preferably from 5 to 45% by weight, preferably from 20 to 40% by weight, based on the total weight of the PESOL.

The present invention thus also provides, in a preferred embodiment, a polyester polyol comprising from 5 to 45% by weight, preferably from 20 to 40% by weight, of units derived from furandicarboxylic acid, based on the total weight of the PESOL, and having an acid number of less than or equal to 1 mg KOH/g, preferably less than or equal to 0.8 mg KOH/g, and an OH number in the range from 50 to 300 mg KOH/g, particularly preferably from 150 to 300 mg KOH/g and very particularly preferably from 160 to 300 mg KOH/g, with the polyester polyol preferably being liquid at 25° C.

The present invention will now be illustrated with the aid of the following examples. Here, the examples serve for purely illustrative purposes and should not be construed as restricting the scope of the invention and of the claims in any way.

Methods:

Viscosity Determination:

The viscosity of the polyols was, unless indicated otherwise, determined at 25° C. in accordance with DIN EN ISO 3219 (Oct. 1, 1994 edition) by means of a Rheotec RC 20 rotational viscometer using the spindle CC 25 DIN (spindle diameter: 12.5 mm; internal diameter of measuring cylinder: 13.56 mm) at a shear rate of 50 l/s.

Measurement of the Hydroxyl Number:

The hydroxyl numbers were determined by the phthalic anhydride method DIN 53240 (Dec. 1, 1971 edition) and are reported in mg KOH/g.

Measurement of the Acid Number:

The acid number was determined in accordance with DIN EN 1241 (May 1, 1998 edition) and is reported in mg KOH/g.

### EXAMPLES

### Example 1

619.7 g of adipic acid and 563.6 g of 2-methyl-1,3-propanediol are firstly introduced into a 2000 ml round-bottom flask provided with thermometer, nitrogen inlet, stirrer and heating mantle. The water of reaction formed is continuously removed from the mixture by distillation.

After 105 g of distillate have been collected, the mixture is cooled to 100° C. and 220.5 g of furandicarboxylic acid are added. The mixture is subsequently condensed further at 200° C. until a product having an acid number of <1.0 mg KOH/g is obtained (samples of the reaction mixture were taken every two to three hours in order to determine the acid number). The total reaction time was 19 hours.

The polymer obtained has the following properties:

Acid number: 0.163 mg KOH/g

Hydroxyl number: 60.23 mg KOH/g

Viscosity at 75° C.: 2352 mPas

### Example 2

573.6 g of phthalic anhydride and 1531.3 g of diethylene glycol are placed in a 3000 ml round-bottom flask provided with thermometer, nitrogen inlet, stirrer and heating mantle, heated to 180° C. and the distillate formed is continuously removed by distillation (30 g of distillate). The mixture is subsequently cooled to 100° C. and 604.5 g of furandicarboxylic acid are added. The mixture is subsequently condensed further at 200° C. until a product having an acid number of <1.0 mg KOH/g is formed (samples of the reaction mixture were taken every two to three hours in order to determine the acid number). The total reaction time was 12 hours.

The polymer obtained has the following properties:

Acid number: 0.69 mg KOH/g

Hydroxyl number: 293.3 mg KOH/g

Viscosity at 25° C.: 10 100 mPas

### Example 3

189.6 g of adipic acid and 297.5 g of 1,4-cyclohexanedimethanol (mixture of isomers) are introduced into a 500 ml round-bottom flask provided with thermometer, nitrogen inline, stirrer and heating mantle and heated to 180° C. Here, 42.4 g (90.6% by weight) of aqueous distillate are removed by distillation. The mixture is subsequently cooled to 100° C. and 67.5 of furandicarboxylic acid are added. The mixture is condensed further at 200° C. until a product having an acid number of <1.0 mg KOH/G is formed (samples of the reaction mixture were taken every two to three hours in order to determine the acid number). The total reaction time was 9 hours.

The polymer obtained has the following properties:

Acid number: <0.1 mg KOH/g

Hydroxyl number: 68.5 mg KOH/g

Viscosity at 75° C.: 37100 mPas

### Example 4

In a manner analogous to the preceding examples, 159.87 g of adipic acid, 57.11 g of trimethylolpropane and 341.08 g of neopentyl glycol are placed in a reaction vessel and condensed at 180° C. with continuous removal of the water. 38.8 g (96% by weight) of the distillate were removed and the mixture was subsequently cooled to 100° C. After this temperature has been reached, 170.8 g of 2,5-furandicarboxylic acid are added and the mixture is again heated to 200° C. The reaction was continued until the product attained an acid number of <1 mg KOH/g (samples of the reaction mixture were taken every two to three hours in order to determine the acid number). The OHN was set by addition of 6.8 g of neopentyl glycol which was reacted at 180° C. for 3 hours. The product was obtained within a reaction time of 13 hours.

The polyester polyol had the following properties

Acid number: <0.2 mg KOH/g

OHN: 118 mg KOH/g

Viscosity at 75° C.: 13 030 mPas

| Acid number | <0.2 | mg KOH/g |
|---|---|---|
| OH number | 118 | mg KOH/g |
| Karl-Fischer | 0.009% | |
| Cone-plate viscometer, 75° C. | 13 030 | mPa*s |

### Comparative Example 1

163.6 g of adipic acid, 174.7 g of 2,5-furandicarboxylic acid and 58.4 g of trimellitic acid are placed in a 500 ml round-bottom flask provided with thermometer, nitrogen inlet, stirrer and heating mantle and heated to 120° C. When the temperature has been attained, 40 ppm of titanium tetrabutoxide are added as catalyst. The homogeneous mixture was subsequently heated further to 180° C. and the water of condensation formed was continuously removed. After the amount of water distilled off decreased, the reaction temperature was increased to 200° C. and vacuum was applied. The vacuum was broken and 40.7 g of neopentyl glycol were additionally added to the mixture in order to set the OHN. Even after a reaction time of 24 hours, an acid number of <1 mg KOH/g could not be attained (samples of the reaction mixture were taken every two to three hours in order to determine the acid number).

The product obtained had the following properties:

Acid number: 6.8 mg KOH/g

OH number: 114.6 mg KOH/g

Cone-plate viscometer, 75° C.: 36 720 mPa*s

The experimental data make it clear that the two-stage, solvent-free process for preparing a PESOL gives a significantly lower acid number of the product compared to the single-stage process.

1. A process for preparing polyester polyols comprising reacting at least one dicarboxylic acid DC or at least one dicarboxylic anhydride DCA and also furandicarboxylic acid with at least one at least bifunctional alcohol A, wherein
in a first step (1), the dicarboxylic acids DC and dicarboxylic anhydrides DCA are reacted with the at least bifunctional alcohols A with removal of the water of condensation at a temperature in the range from 100 to 300° C. until at least 80% by weight of the water of condensation have been removed, based on the total amount of water which can be produced by condensation of the reactants, with the amount of the water of condensation being determined by means of the water removed by distillation from the reaction vessel, and with the dicarboxylic acid DC not being furandicarboxylic acid and with all dicarboxylic anhydrides DCA being phthalic anhydride, and
in a second step (2a), after the reaction mixture has reached a temperature in the range from 50 to 150° C., furandicarboxylic acid is added and subsequently
in a next step (2b), the reaction mixture is reacted further at a temperature in the range from 150 to 300° C. until an acid number of less than or equal to 1 mg KOH/g has been reached,
with an additional organic solvent being used in none of the process steps.

2. The process for preparing polyester polyols according to claim 1, wherein the reaction in step (2b) is carried out to an acid number of less than or equal to 0.7 mg KOH/g.

3. The process for preparing polyester polyols according to claim 1, wherein the temperature in the first step (1) is in the range from 150 to 250° C.

4. The process for preparing polyester polyols according to claim 1, wherein the temperature in step (2a) is in the range from 80 to 120° C.

5. The process for preparing polyester polyols according to claim 1, wherein the temperature in step (2b) is in the range from 160 to 280° C.

6. The process for preparing polyester polyols according to claim 1, wherein at least one of the dicarboxylic acids DC are selected from the group consisting of aliphatic and aromatic dicarboxylic acids.

7. The process for preparing polyester polyols according to claim 1, wherein at least one of the dicarboxylic acids DC are adipic acid.

8-10. (canceled)

11. The process for preparing polyester polyols according to claim 1, wherein no fatty acids are used.

12. The process for preparing polyester polyols according to claim 1, wherein no monocarboxylic acids are used.

13. (canceled)

14. The process for preparing polyester polyols according to claim 1, wherein at least one of the bifunctional alcohols A are selected from the group consisting of aliphatic and aromatic bifunctional alcohols.

15. The process for preparing polyester polyols according to claim 1, wherein at least one of the bifunctional alcohols A are selected from the group consisting of aliphatic bifunctional alcohols.

16. The process for preparing polyester polyols according to claim 1, wherein at least one of the bifunctional alcohols A are selected from the group consisting of diethylene glycol (DEG), methyl ethyl glycol (MEG), 2-methyl-1,3-propanediol, 1,4-cyclohexanedimethanol, neopentyl glycol, trimethylolpropane, and polyether polyols.

17. The process for preparing polyester polyols according to claim 1, wherein at least one of the bifunctional alcohols A are selected from the group consisting of DEG, MEG, and polyether polyols.

18. The process for preparing polyester polyols according to claim 1, wherein at least one of the bifunctional alcohols A is DEG.

19. The process for preparing polyester polyols according to claim 1, wherein the OH number of the product is in the range from 50 to 300 mg KOH/g.

20. The process for preparing polyester polyols according to claim 1, wherein the product is a liquid at 25° C. having a viscosity of 1 to 40,000 mPas.

21. The process for preparing polyester polyols according to claim 1, wherein the product has a viscosity at 75° C. of less than or equal to 40,000 mPas, where the viscosity is determined in accordance with DIN EN ISO 3219 (Oct. 1, 1994 edition) by means of a Rheotec RC 20 rotational viscometer using spindle CC 25 DIN (spindle diameter: 12.5 mm; internal diameter of measuring cylinder: 13.56 mm) at a shear rate of 50 l/s at 25° C.

22. The process for preparing polyester polyols according to claim 1, wherein the proportion of furandicarboxylic acid is from 5 to 45% by weight, based on the total batch.

23. A polyester polyol preparable by the process of claim 1, and having an acid number of less than or equal to 1 mg KOH/g.

24. (canceled)

25. The polyester polyol according to claim 23, wherein the polyester polyol is liquid at 25° C. and/or the polyester polyol has a viscosity at 75° C. of less than or equal to 40,000 mPas, where the viscosity is determined in accordance with DIN EN ISO 3219 (Oct. 1, 1994 edition) by means of a Rheotec RC 20 rotational viscometer using spindle CC 25 DIN (spindle diameter: 12.5 mm; internal diameter of measuring cylinder: 13.56 mm) at a shear rate of 50 l/s at 25° C.
